(19) United States
(12) Patent Application Publication
(10) Pub. No.: US 2019/0048954 A1
(43) Pub. Date: Feb. 14, 2019

(54) FRICTIONAL PIECE

(71) Applicant: Schaeffler Technologies AG & Co. KG, Herzogenaurach (DE)

(72) Inventor: Johannes Bernhardt, Bühlertal (DE)

(73) Assignee: Schaeffler Technologies AG & Co. KG, Herzogenaurach (DE)

(21) Appl. No.: 16/076,943

(22) PCT Filed: Jan. 27, 2017
(86) PCT No.: PCT/DE2017/100054

§ 371 Date: Aug. 9, 2018

(30) Foreign Application Priority Data
Feb. 26, 2016 (DE) 10 2016 203 051.5
Apr. 7, 2016 (DE) 10 2016 205 802.9

(51) Int. Cl. F16D 69/00; F16D 13/72; F16D 13/74; F16D 13/64

(52) U.S. Cl. CPC F16D 69/00; F16D 13/72; F16D 13/648; F16D 13/64; F16D 2069/004; F16D 13/74

(57) ABSTRACT

A frictional piece is disclosed, for example, for a wet frictionally engaging mechanism. The frictional piece may include at least one frictional surface, which has at least one flow path for the passage of a fluid. The frictional piece may have at least one fluidic resistance, which reduces a flow rate of the fluid along the flow path in such a way that a cooling rate is increased during operation of the frictional piece when the fluid is passed along the flow path. A clutch is also disclosed having at least one of the frictional pieces.

### CROSS-REFERENCE TO RELATED APPLICATIONS

This application is the U.S. National Phase of PCT Appln. No. PCT/DE2017/100054 filed Jan. 27, 2017, which claims priority to DE 10 2016 203 051.5 filed Feb. 26, 2016 and DE 10 2016 205 802.9 filed Apr. 7, 2016, the entire disclosures of which are incorporated by reference herein.

### TECHNICAL FIELD

The disclosure relates to a frictional piece for a wet frictionally engaging mechanism, having at least one frictional surface, which has at least one flow path for the passage of a fluid. The disclosure furthermore relates to a clutch having at least one frictional piece of this kind.

### BACKGROUND

German Laid-Open Application DE 10 2012 014 811 A1 discloses a frictional piece for a frictionally engaging mechanism having an annular frictional surface, which has an inner edge and an outer edge, wherein an inner circumferential slot, an outer circumferential slot and at least one intermediate circumferential slot arranged between the inner and the outer circumferential slot in the radial direction are provided in the frictional surface, said slots each extending in a zigzag or undulating form between the inner and outer inflection points, and a flow connection is provided between the inner edge and the inner circumferential slot, between the mutually adjacent circumferential slots and between the outer circumferential slot and the outer edge, wherein the frictional piece has a friction lining support, wherein the frictional surface is formed by a friction lining, preferably a paper friction lining, applied to the friction lining support and comprising a plurality of mutually spaced friction lining segments, between which the circumferential slots and the inner and/or outer edge slots, optionally also the intermediate slots, are formed.

A similar frictional piece is known from German Laid-Open Application DE 10 2012 014 804 A1, wherein connecting slots extend along a radial line and/or the connecting slots are of rectilinear design. German Patent DE 101 57 483 C2 discloses a shaped body consisting of fiber-reinforced ceramic composite materials comprising a core zone and at least one top layer, which has a higher thermal expansion coefficient than the core zone, wherein the top layer is a silicon carbide-rich top layer containing at least thirty percent by mass of silicon carbide and being made up of segments, which are separated from one another by regions free from top layer material in the form of gaps or by webs composed of a material different from the material of the top layer.

German Laid-Open Application DE 10 2006 009 565 A1 discloses a brake disk having at least one annular frictional surface, which is preferably provided on both outer sides and against which a brake lining can be pressed for the purpose of braking, wherein the frictional surface consists of a multiplicity of partial segments which are at least partially separated from one another materially by expansion joints, wherein the depth of the expansion joints is greater than the permissible wear of the frictional surface.

German Laid-Open Application DE 2 353 133 discloses a friction disk, in particular for use in clutches and disk brakes, wherein the disk is formed by five layers, wherein the first layer is composed of frictional material, the second layer is composed of a material with a low elastic modulus for pressure, the third layer is composed of a high-strength core, the fourth layer is composed of a material with a low elastic modulus for pressure, and the fifth layer is composed of frictional material, wherein the frictional material of the first and fifth layers consists of a large number of individual particles.

German Patent DE 103 42 271 B4 discloses a friction lining plate for a wet frictional selector element, having at least one frictional surface in the form of an annular disk, which serves for frictional engagement and which, starting from the inside diameter of the frictional surface, has slots through which coolant flows, wherein the slots form two superposed sets of slots, the friction lining plate can be rotated without a preferential direction of rotation in the installed state, and the frictional surface does not have any slot edges aligned perpendicularly to the direction of rotation.

German Patent DE 44 20 959 B4 discloses a hydrodynamic torque converter having frictional surfaces which, even when in axial contact, allow a radially inward oil flow via the channels, wherein an oil volume flowing via channels can be adjusted by means of at least one valve in accordance with at least one operating parameter of the torque converter and/or of the machine driving said converter or of the transmission driven by the torque converter.

International Application WO 2008/055457 A2 discloses a clutch assembly having a housing assembly in which a fluid flow for cooling frictional surface arrangements can be generated, wherein means for generating at least one circuit passing repeatedly through at least one frictional-surface-carrying element of the friction arrangement and guiding the fluid flow before the fluid flow emerges from the clutch assembly are provided, wherein a single cooling channel is embodied as a slot machined into the surface of the frictional surface of the frictional-surface-carrying element, wherein the single cooling channel is embodied with a decreasing cross-sectional area in the flow direction.

### SUMMARY

It is one object of the disclosure to improve a frictional piece for a wet frictionally engaging mechanism, having at least one frictional surface, which has at least one flow path for the passage of a fluid, especially in respect of its functionality.

The object is achieved, in the case of a frictional piece for a wet frictionally engaging mechanism, having at least one frictional surface, which has at least one flow path for the passage of a fluid, by virtue of the fact that the frictional piece has at least one fluidic resistance, which reduces a flow rate of the fluid along the flow path in such a way that a cooling performance is increased during operation of the frictional piece when the fluid is passed along the flow path. The fluid is preferably a cooling and/or lubricating medium, such as oil. During the operation of a clutch fitted with the frictional piece, frictional heat is generated. The frictional heat is dissipated at least partially by the fluid. For this purpose, use is advantageously made of a multiplicity of flow paths, through which the fluid flows. The fluidic resistance reduces the flow rate of the fluid along the flow path. Heat transfer between the frictional surface and the fluid can thereby be improved. Since the cooling effect depends not only on a heat transfer coefficient but also on a dwell time of the fluid on the frictional surface, an increase in the cooling performance can advantageously be achieved by reducing the flow rate of the fluid. At the same time, it should be noted that the reduction in the heat transfer coefficient due to a reduction in a “Nusselt number” is overcompensated.

The heat transfer coefficient in respect of convective heat transfer is determined both by the flow conditions and also by the fluid properties, in particular oil properties. A higher flow rate leads to an increase in the Nusselt number and hence also to an increase in the heat transfer coefficient. Accordingly, conventional clutch systems and the frictional pieces or lining plates installed therein are generally designed in such a way that a high flow rate of the fluid, in particular of the oil, in corresponding slots is achieved. At conventional oil volume flows, the high flow rate of the fluid, in particular oil, in the slot in combination with large slot cross sections results in low levels of slot filling. That is to say that the slot cross sections are partially filled with fluid, in particular oil, and to a considerable extent by air. According to one aspect of the disclosure, the flow rate of the fluid, in particular oil, is reduced by a suitable slot configuration. The slot filling can thereby advantageously be increased. As a result, in turn, heat transfer is improved.

In view of the fact that the cooling depends not only on heat transfer coefficients but also on the dwell time of the fluid, in particular oil, on the surface of the clutch components, an increase in the cooling performance can be achieved by reducing the flow rate of the fluid, in particular oil, if the reduction in the heat transfer coefficient owing to the reduction in the Nusselt number is overcompensated. The important factor here is a relatively small slot cross section in the outer region of the frictional piece, in particular of the lining plate, in order to ensure throttling of the oil flow. In this case, the slot cross section can decrease continuously and/or discontinuously from the inside outward. Slot geometries with increases in cross section and/or decreases in cross section in the inner and central regions of the frictional piece, in particular of the lining plate, are likewise possible.

One embodiment of the frictional piece includes that the frictional surface has substantially the form of a circular-ring disk with an inner radius, at which the fluid enters, and with an outer radius, at which the fluid exits. By an appropriate configuration of the frictional surface, a multiplicity of flow paths is provided, which extends substantially in radial directions. The flow paths are delimited by channels and/or elongate depressions, for example, such as grooves or slots, which are provided in the frictional surface.

Another illustrative embodiment of the frictional piece includes that the fluidic resistance is arranged in an outer region of the frictional surface. As a result, the dwell time of the fluid in the region of the frictional surface is extended in a simple manner. The fluidic resistance can be embodied as an obstacle in the flow path of the fluid, for example.

Another illustrative embodiment of the frictional piece includes that the flow path is delimited by a slot, which has at least one region with a reduced slot cross section in order to form the fluidic resistance. The slot has a constriction, for example, in order to form the fluidic resistance. The slot with the region of reduced slot cross section can be produced in a simple and low-cost manner.

Another illustrative embodiment of the frictional piece includes that the slot cross section decreases along the flow path. Depending on the embodiment, the slot cross section can decrease continuously or discontinuously along the flow path. Here, the principal concern is merely that the slot cross section should decrease from the entry of the fluid, e.g., preferably radially on the inside, to the exit of the fluid, e.g., radially on the outside.

Another illustrative embodiment of the frictional piece includes that the flow path for the passage of the fluid has at least one branch. The flow path can advantageously be divided up or branched. Such a division or branching is advantageously obtained by an obstacle in the flow path, around which the fluid flows, for example.

Another illustrative embodiment of the frictional piece includes that the flow path for the passage of the fluid is delimited by a slot in a friction lining. The friction lining is a paper lining, for example. The slot can be produced in the friction lining by stamping, for example.

Another illustrative embodiment of the frictional piece includes that the flow path for the passage of the fluid is delimited by friction lining pieces. The slots are obtained in a simple manner between two or more friction lining pieces which are spaced apart.

Another illustrative embodiment of the frictional piece includes that at least one friction lining piece has a larger circumferential extent radially on the outside than radially on the inside. A circumferential extent refers to a dimension of the friction lining piece in the circumferential direction. A fluidic resistance which is effective in the sense according to the disclosure is created in a simple manner by the larger circumferential extent radially on the outside.

Another illustrative embodiment of the frictional piece includes that the friction lining piece has a concave curvature along the flow path. By the concave curvature of the friction lining piece along the flow path, a constriction between two friction lining pieces, which forms the fluidic resistance, is created in a simple manner.

Another illustrative embodiment of the frictional piece includes that the friction lining piece is of boot-like design, wherein a boot toe is arranged radially on the outside and extends substantially in a circumferential direction. A constriction between two friction lining pieces, which forms the fluidic resistance, is thereby created in a simple manner.

Another illustrative embodiment of the frictional piece includes that the friction lining pieces have substantially the form of polygons, in particular rectangles. As an alternative, the friction lining pieces can also have substantially the form of circles.

Another illustrative embodiment of the frictional piece includes that, radially on the outside, a small friction lining piece is arranged between two large friction lining pieces, which extend from radially on the inside to radially on the outside. The friction lining pieces are embodied as rectangles, for example.

Another illustrative embodiment of the frictional piece includes that, radially on the outside, a small friction lining piece is arranged between two rows of small friction lining pieces, which extend from radially on the inside to radially on the outside. The small friction lining pieces are preferably all embodied in the same way, in particular as rectangles.

Another illustrative embodiment of the frictional piece includes that a friction lining piece which is long in the circumferential direction is arranged radially to the outside of at least two rows of small friction lining pieces, which are arranged radially. The long friction lining piece and the small friction lining pieces are embodied as rectangles, for example.

Another illustrative embodiment of the frictional piece includes that at least one friction lining piece is embodied substantially in the shape of a mushroom, wherein a mushroom head of the friction lining piece embodied substantially in the shape of a mushroom is arranged radially on the outside. It is thereby possible to form a constriction between two friction lining pieces in a simple manner.

The disclosure furthermore relates to a clutch having at least one frictional piece described above. The clutch is preferably a wet multiplate clutch. The frictional piece described above forms a friction plate in the wet multiplate clutch. The wet multiplate clutch is preferably used in the automotive sector.

### BRIEF DESCRIPTION OF THE DRAWINGS

Further advantages, features and details of the disclosure will become apparent from the following description, in which various illustrative embodiments are described in detail with reference to the drawing, in which:

FIG. 1 shows a greatly simplified illustration of a lining support according to an embodiment of the disclosure having two wet friction linings in cross section;

FIG. 2 shows an arrangement of the lining support with the wet friction linings from FIG. 1 between two mating clutch pieces composed of a steel material;

FIG. 3 shows a simplified illustration of a plate pack with wet clutch pieces and with wet mating clutch pieces composed of a steel material, and

FIGS. 4 to 6 show various frictional pieces in plan view with fluidic resistances, by which a flow rate of a fluid along a flow path is reduced to such an extent that a cooling performance during the operation of the frictional piece as the fluid is passed along the flow path is increased.

### DETAILED DESCRIPTION

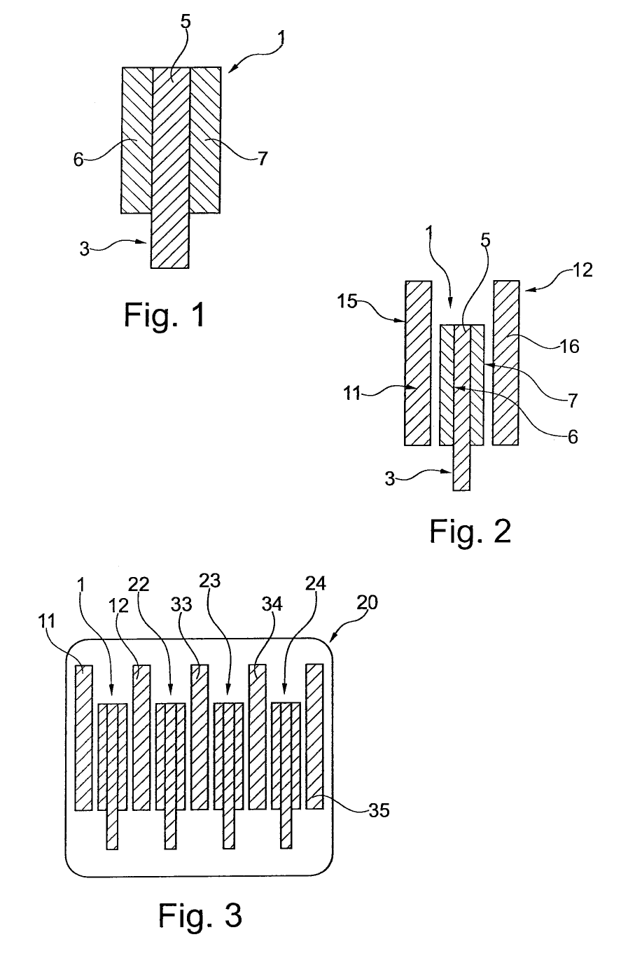

A wet clutch piece 1 having a lining support 3 is illustrated in greatly simplified form in cross section in FIG. 1. The lining support 3 comprises a main body 5, which has substantially the form of a circular-ring disk with a rectangular ring cross section.

Two wet friction linings 6, 7 are secured on the main body 5. The wet friction linings 6, 7 likewise have the form of circular-ring disks with a rectangular ring cross section. The wet friction linings 6, 7 have the same outside diameter as the main body 5 of the lining support 3. The lining support 3 has a smaller inside diameter than the wet friction linings 6, 7.

The wet clutch piece 1 is an inner plate of a multiplate clutch, for example. To form a rotational connection to an inner plate carrier of the multiplate clutch, the lining support 3 has internal teeth radially on the inside, for example.

In FIG. 2, the wet clutch piece 1 from FIG. 1 is arranged between two wet mating clutch pieces 11, 12. The two mating clutch pieces 11, 12 each have a main body 15, 16 in the form of a circular-ring disk with a rectangular ring cross section.

An inside diameter of the main bodies 15, 16 of the mating clutch pieces 11, 12 is precisely the same as the inside diameter of the wet friction linings 6, 7 in the lining support 3. However, the mating clutch pieces 11, 12 have a larger outside diameter than the lining support 3 having the wet friction linings 6, 7.

The mating clutch pieces 11, 12 are outer plates of the multiplate clutch described above, for example. To form a rotational connection to an outer plate carrier, the mating clutch pieces 11, 12 are advantageously equipped with external teeth radially on the outside.

The wet friction linings 6, 7 on the lining support 3 are formed from a wet friction lining material. The lining support 3 is formed from a steel material. The mating clutch pieces 11, 12 are likewise formed from a steel material.

A plate pack 20 of a multiplate clutch is illustrated in simplified form in FIG. 3. In addition to the wet clutch piece 1, the plate pack 20 comprises three further wet clutch pieces 22, 23 and 24. Wet clutch pieces 22 to 24 are embodied in precisely the same way as wet clutch piece 1. The wet clutch pieces 1, 22 to 24 form inner plates in the plate pack 20.

In addition to the mating clutch pieces 11, 12 from FIG. 2, the plate pack 20 furthermore comprises three further wet mating coupling pieces 33, 34, 35. The wet clutch pieces 1, 22 to 24 are arranged alternately with the wet mating clutch pieces 11, 12, 33 to 35.

The mating clutch pieces 11, 12 and 33 to 35 form outer plates of the plate pack 20. In this case, the mating clutch piece 11 forms an end plate (on the left in FIG. 3) of the plate pack 20. Similarly, the mating clutch piece 35 (arranged on the right in FIG. 3) forms a second end plate of the plate pack 20. The wet clutch pieces 1, 22 to 24 are each arranged between two mating clutch pieces 11, 12; 33, 34; 34, 35.

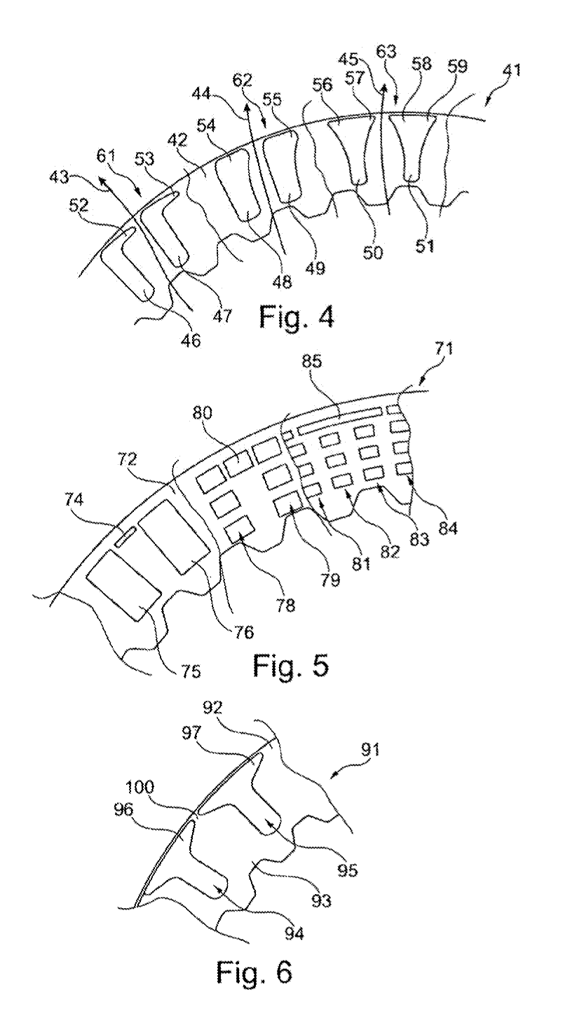

In FIGS. 4 to 6, friction pieces 41; 71; 91 according to various illustrative embodiments are illustrated in a plan view of a frictional surface 42; 72; 92. The frictional pieces 41; 71; 91 preferably form wet clutch pieces (1; 22 to 24 in FIGS. 1 to 3) of a wet multiplate clutch.

In the case of the frictional piece 41 illustrated in FIG. 4, flow paths for a fluid, in particular cooling oil, are shown by arrows 43 to 45 in three circumferential sections. The fluid enters radially on the inside in the region of internal teeth. The fluid then flows radially outward along the frictional surface 42 and emerges there.

Flow path 43 is delimited on the frictional surface 42 by two friction lining pieces 46, 47. The friction lining pieces 46, 47 have the form of boots with boot toes 52, 53. The boot toes 52, 53 of the friction lining pieces 46, 47 are arranged radially on the outside and extend in the circumferential direction, this being clockwise in FIG. 4. This is a simple way of obtaining a fluidic resistance 61, by which the flow rate of the fluid along flow path 43 is reduced.

Flow path 43 is delimited on the frictional surface 42 by two friction lining pieces 48, 49. Radially on the outside, the friction lining pieces 48, 49 have widened portions 54, 55, which extend clockwise in the circumferential direction. By widened portion 54, a fluidic resistance 62 is created in a simple manner between the friction lining pieces 48, 49. The fluidic resistance 62 is formed by a narrowing of the cross section in a slot between the friction lining pieces 48, 49.

Flow path 45 is delimited by two friction lining pieces 50, 51, which have widened portions 56, 57; 58, 59 radially on the outside. The mutually facing widened portions 57, 58 of the friction lining pieces 50, 51 create a constriction or a fluidic resistance 63 in the flow path 45 between the friction lining pieces 50, 51.

In the case of the frictional piece 71 in FIG. 5, flow paths from radially on the inside to radially on the outside are provided with constrictions by different configurations and arrangements of substantially rectangular friction lining pieces in order to form fluidic resistances or constrictions. A first flow path is delimited by a friction lining piece 74, which is arranged radially on the outside and has the form of a relatively small rectangle.

Friction lining piece 74 is arranged between two friction lining pieces 75 and 76. The friction lining pieces 75, 76 likewise have the form of rectangles, but they extend from radially on the inside to radially on the outside over the frictional surface 72. A relatively wide slot for the fluid is obtained between the friction lining pieces 75, 76.

This slot is delimited by friction lining piece 74, which forms an obstacle in the flow path. By friction lining piece 74, the flow path is divided into a first flow path between friction lining piece 74 and friction lining piece 75 and into a second flow path between friction lining piece 74 and friction lining piece 76.

Another fluidic resistance in FIG. 5 is formed by a friction lining piece 80. Friction lining piece 80 has the form of a rectangle and is arranged between two rows 78, 79 of friction lining pieces, which likewise have the form of rectangles. Arranged in each of the rows 78, 79 are three friction lining pieces, which have the same form and size as friction lining piece 80. Friction lining piece 80 is arranged radially on the outside between the two rows 78, 79.

Further flow paths are obtained by four rows 81 to 84. A total of four friction lining pieces is arranged in rows 81 and 84 from radially on the inside to radially on the outside. Just three friction lining pieces are arranged in each of rows 82 and 83. A friction lining piece 85 which is elongate in the circumferential direction is arranged radially to the outside of rows 82 and 83 and is arranged between rows 81 and 84 in the circumferential direction. By friction lining piece 85, a fluidic resistance for several flow paths from radially on the inside to radially on the outside is created in a simple manner.

The frictional piece 91 in FIG. 6 comprises a slot 93 in the frictional surface 92. The slot 93 is delimited by two friction lining pieces 94, 95, which are of substantially mushroom-shaped configuration. The mushroom-shaped friction lining pieces 94, 95 have a head 96, 97 radially on the outside. The heads 96, 97 of the friction lining pieces 94, 95 create a constriction 100 in the slot 93. A fluidic resistance is thereby created in a simple manner in the flow path for the fluid from radially on the inside to radially on the outside.

### LIST OF REFERENCE SIGNS

1 wet clutch piece

3 lining support

5 main body

6 wet friction lining

7 wet friction lining

11 mating clutch piece

12 mating clutch piece

15 main body

16 main body

20 plate pack

22 wet clutch piece

23 wet clutch piece

24 wet clutch piece

33 mating clutch piece

34 mating clutch piece

35 mating clutch piece

41 frictional piece

42 frictional surface

43 flow path

44 flow path

45 flow path

46 friction lining piece

47 friction lining piece

48 friction lining piece

49 friction lining piece

50 friction lining piece

51 friction lining piece

52 boot toe

53 boot toe

54 widened portion

55 widened portion

56 widened portion

57 widened portion

58 widened portion

59 widened portion

61 fluidic resistance

62 fluidic resistance

63 fluidic resistance

71 frictional piece

72 frictional surface

74 friction lining piece

75 friction lining piece

76 friction lining piece

78 row

79 row

80 friction lining piece

81 row

82 row

83 row

84 row

85 friction lining piece

91 frictional piece

92 frictional surface

93 slot

94 friction lining piece

95 friction lining piece

96 head

97 head

100 constriction

1. A frictional piece for a wet frictionally engaging mechanism, comprising:
at least one frictional surface, which has at least one flow path for the passage of a fluid, wherein the frictional piece has at least one fluidic resistance, which reduces a flow rate of the fluid along the flow path in such a way that a cooling rate is increased during operation of the frictional piece when the fluid is passed along the flow path.

2. The frictional piece as claimed in claim 1, wherein the frictional surface is shaped as a circular-ring disk with an inner radius, at which the fluid enters, and with an outer radius, at which the fluid exits.

3. The frictional piece as claimed in claim 1, wherein the fluidic resistance is arranged in an outer region of the frictional surface.

4. The frictional piece as claimed in claim 1, wherein the flow path is delimited by a slot, which has at least one region with a reduced slot cross section in order to form the fluidic resistance.

5. The frictional piece as claimed in claim 4, wherein the slot cross section decreases along the flow path.

6. The frictional piece as claimed in claim 1, wherein the flow path for the passage of the fluid has at least one branch.

7. The frictional piece as claimed in claim 1, wherein the flow path for the passage of the fluid is delimited by a slot in a friction lining.

8. The frictional piece as claimed claim 1, wherein the flow path for the passage of the fluid is delimited by friction lining pieces.

9. The frictional piece as claimed in claim 8, wherein at least one friction lining piece has a larger circumferential extent radially on the outside than radially on the inside.

10. A clutch having at least one frictional piece as claimed in claim 1.
